(19) United States
(12) Patent Application Publication
(10) Pub. No.: US 2016/0092595 A1
(43) Pub. Date: Mar. 31, 2016

(54) Systems And Methods For Processing Graphs

(71) Applicant: Alcatel-Lucent USA Inc., Murray Hill, NJ (US)

(72) Inventors: William S. Kennedy, Chelsea (CA); Yihao Lisa Zhang, New Providence, NJ (US)

(73) Assignee: Alcatel-Lucent USA Inc., Murray Hill, NJ (US)

(21) Appl. No.: 14/501,758

(22) Filed: Sep. 30, 2014

(51) Int. Cl. G06F 17/30

(52) U.S. Cl. CPC G06F 17/30958; G06F 17/30324; G06F 17/3053

(57) ABSTRACT

Systems and methods are provided for organizing and processing information in a graph having a number of nodes interconnected by a number of edges. An array E lists neighboring nodes for nodes of the graph that have at least one neighboring node in a determined order of the nodes. Positions in array E of a last neighboring node listed in array E for respective nodes are listed as corresponding entries in an array V based on the determined order of the nodes. In various aspects, array E and array V are used to determine information for the graph, including degrees or neighboring nodes of one or more given nodes of the graph. The system and methods disclosed herein are applicable for determining relative ranks for the nodes of the graph.

### TECHNICAL FIELD

The present disclosure is directed towards systems and methods for data analytics. More particularly, it is directed towards systems and methods for organizing and extracting information from data sets representing graphs having a large number of interconnected nodes.

### BACKGROUND

This section introduces aspects that may be helpful in facilitating a better understanding of the systems and methods disclosed herein. Accordingly, the statements of this section are to be read in this light and are not to be understood or interpreted as admissions about what is or is not in the prior art.

The recent explosion in the amount of accessible data, due in part to the rapid increase in online interactions, has led many research, business and marketing communities to depict information in a graphical manner. While graphical models (e.g., social network models, call data models, etc.) can provide intuitive views of relationships or interconnections between raw data, determining how various entities (e.g., subscribers, groups, people, objects, machines, data, etc.) interact or relate with other entities from the graphs typically involves performing a very large number of computations. As many graphical models can include massive number of nodes (or entities) interconnected by many more connections, there is a need for scalable systems and methods for reducing the time and computational effort for mining relevant information from data represented by the graphical models.

### BRIEF SUMMARY

Systems and methods are provided for organizing and processing information in a graph representing a number of nodes interconnected by a number of edges. An array E lists neighboring nodes for nodes of the graph that have at least one neighboring node in a determined order of the nodes. Positions in array E of a last neighboring node listed in array E for respective nodes are listed as corresponding entries in an array V based on the determined order of the nodes. In various aspects, array E and array V are generated and used to determine relevant information for the graph, including degrees or neighboring nodes of one or more given nodes of the graph. The system and methods disclosed herein are believed to be applicable in a variety of contexts and applications, such as in a system for determining relative ranking for the nodes of the graph.

In one aspect, a system and method for processing a graph having an N number of nodes interconnected by an M number of edges includes generating, using a processor, an array E having an M number of entries for listing neighboring nodes for respective nodes of the N nodes of the graph that have at least one neighboring node, wherein the neighboring nodes are listed in array E for the respective nodes of the graph that have at least one neighboring node in a determined order assigned to the N number of nodes of the graph. The system and method further includes generating, using the processor, an array V having an N number of entries that correspond, in the determined order, to the N number of nodes of the graph, and, populating entries of array V that correspond to the nodes of the graph having at least one neighboring node listed in array E to respectively indicate a position in array E of a last neighboring node listed in array E for the corresponding node.

In one aspect the system and method includes populating at least one of the entries of array V that corresponds to a node of the graph that does not have any neighboring nodes with a value of an immediately prior entry populated into array V.

In one aspect the system and method includes populating at least one of the entries of array V that corresponds to a node of the graph that does not have any neighboring nodes with a value of zero.

In one aspect the system and method includes determining a degree of a given node i of the N nodes of the graph from one or more populated entries of array V. In one aspect determining the degree of the given node i from one or more populated entries of array V further includes computing a value V[i]−V[i−1] from array V as the degree of the given node i.

In one aspect the system and method includes determining that the given node i does not have any neighboring nodes from array V based on a determination that V[i]−V[i−1]=0.

In one aspect the system and method includes determining that the given node i of the graph has at least one neighboring node from array V based on a determination that V[i]−V[i−1]>=1.

In one aspect the system and method includes determining neighboring nodes of a given node i of the N nodes of the graph using array V and array E by computing entries in array E starting from E[V[i−1]+1] and up to and including E[V[i]].

In one aspect the system and method includes determining whether a first given node of the N nodes of the graph is a neighboring node of a given node i of the N nodes of the graph by searching entries in array E from E[V[i−1]+1] and up to and including E[V[i]].

In one aspect the system and method includes utilizing array E and array V to determine a relative rank for one or more nodes of the N nodes of the graph.

These and other embodiments will become apparent in light of the following detailed description herein, with reference to the accompanying drawings.

### BRIEF DESCRIPTION OF THE DRAWINGS

FIG. 1 illustrates an example of a graphical model of interconnected nodes in accordance with an aspect of the disclosure.

FIG. 2 illustrates the neighboring nodes and degrees of the interconnected nodes illustrated in FIG. 1.

FIG. 3 illustrates an example of a flow-diagram for processing a graph having an N number of nodes and an M number of interconnections in accordance with various aspects of the disclosure.

FIG. 4 illustrates an array E for indicating neighboring nodes based on an assigned order in accordance with an aspect of the disclosure.

FIGS. 5a, 5b illustrate alternative embodiments for an array E based on different types interconnections of the nodes of FIG. 1.

FIG. 6 illustrates an array V indicating positions of neighboring nodes of array E in accordance with an aspect of the disclosure.

FIG. 7 illustrates an example of an apparatus for implementing various aspects of the disclosure.

### DETAILED DESCRIPTION

Various aspects of the disclosure are described below with reference to the accompanying drawings, in which like numbers refer to like elements throughout the description of the figures. The description and drawings merely illustrate the principles of the disclosure. It will be appreciated that those skilled in the art will be able to devise various arrangements that, although not explicitly described or shown herein, embody the principles and are included within spirit and scope of the disclosure.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The present disclosure describes aspects for processing a graph of multiple interconnected nodes into a collection of datasets that can be used to determine and extract various types of information regarding the entities and interconnections of the graph. The aspects disclosed herein are applicable to graphs having any number of nodes and interconnections, and are particularly applicable for graphs that include a large number of nodes and interconnections (e.g., many thousands, millions, or billions of nodes or interconnections).

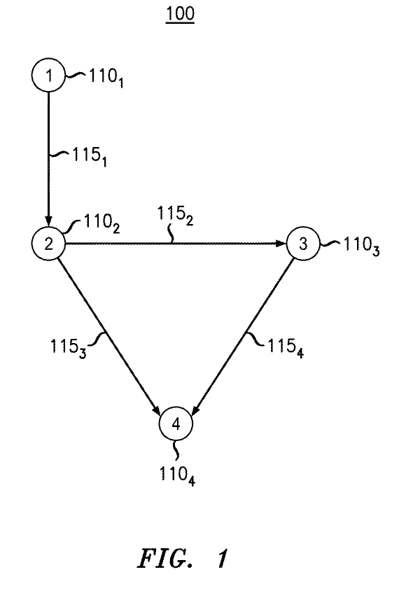

FIG. 1 illustrates a greatly simplified example of a graph 100 that includes four interconnected nodes (or vertexes) 110₁, 110₂, 110₃, and 110₄ (collectively referenced as nodes 110). The nodes 110₁, 110₂, 110₃, and 110₄ of graph 100 are directly or indirectly interconnected via unidirectional paths or edges 115₁, 115₂, 115₃, and 115₄ (collectively referenced as edges 115). Although only a few nodes 110 and edges 115 are depicted in graph 100 for aiding the understanding of the principles of the disclosure, it will be appreciated that in practice a graph may include a large number (e.g., many thousands, millions or billions) of nodes 110 or edges 115. In addition, the graph 100 may be an entire graph, or may be a sub-set of a larger graph or graphs.

In various embodiments, the nodes 110 of the graph 100 may represent one or more types of entities (e.g., subscribers, groups, people, objects, machines, data, etc.), and the edges 115 may represent relationships between the various entities of the graph 100. By way of some examples, in one non-limiting embodiment the graph 100 may be a model of call data records of a telecommunications service provider. In this case, the nodes 110 may represent the users or subscribers (or user equipment) of the telecommunication service provider, and the unidirectional edges 115 may represent calls from particular ones of the subscribed users (or user equipment) to other subscribed users (or user equipment). In another non-limiting embodiment, the graph 100 may be a model of web data collected or generated by an Internet service or search provider. In this case, the nodes 110 may represent, for example, different web-pages (or websites) hosted in one or more servers, and the unidirectional edges 115 may represent hypertext-markup links from one webpage (or website) to another webpage (or website).

In yet another non-limiting embodiment, the graph 100 may model social network data of a social network provider. In this case, the nodes 110 may represent various users or subscribers of a social network, and the unidirectional edges 115 may represent a social (or other) relationship between one subscriber and other subscribers. Although particular examples of the graph 100 may be referenced to illustrate various aspects of the disclosure, it will be understood that the present disclosure is not limited to particular embodiments of graphs, entities, or interconnections.

One common computational query of fundamental interest with respect to graphs, such as graph 100, is whether a given node is a neighbor node of another given node (and vice-versa). In general, a first node is a neighbor of a second node if the first node can be reached from the second node without traversing any intervening nodes. Thus, it can be seen from the simple example of FIG. 1 that node 110₁ has a single neighboring node, namely, node 110₂, since node 110₂ is the only node that can be reached directly from node 110₁ (via unidirectional edge 115₁) without traversing any intervening nodes. Similarly, it can be seen in FIG. 1 that node 110₂ has two neighboring nodes, namely, node 110₃ and node 110₄, and, lastly, node 110₃ has one neighboring node, namely, node 110₄.

For clarity and completeness, it is noted that node 110₄ as depicted in the example of FIG. 1 does not have any neighboring nodes, since no other node of graph 100 can be reached from 110₄. In addition, although node 110₂ is a neighboring node of node 110₁, the converse is not true; node 110₁ is not a neighboring node of node 110₂ since node 110₁ cannot be reached from node 110₂. It is noted that in other embodiments, two nodes of a graph such nodes 110₁ and 110₂ of graph 100 would be neighboring nodes of each other if the two nodes are directly interconnected to each other via, for example, a bi-directional edge, or by two opposing unidirectional edges as will be appreciated by those of ordinary skill in the art.

Another common computational query of interest with respect to graphs, such as graph 100, is the determination of a degree of a given node. In general, a degree of a node is the number of edges (or paths) from the node to other nodes. Thus, in the example of FIG. 1, the degree of node 110₁ is one since there is a single direct path or edge 115₁ from node 110₁ to another node of the graph. Similarly, the degree of node 110₂ is two because there are two direct paths 115₂ and 115₃ from node 110₂ to other nodes of the graph. The degree of node 110₃ is one, since there is a single direct path 115₄ from node 110₃ to another node of the graph). Lastly, the degree of node 110₄ is zero because there no paths from node 110₄ to other nodes of the graph.

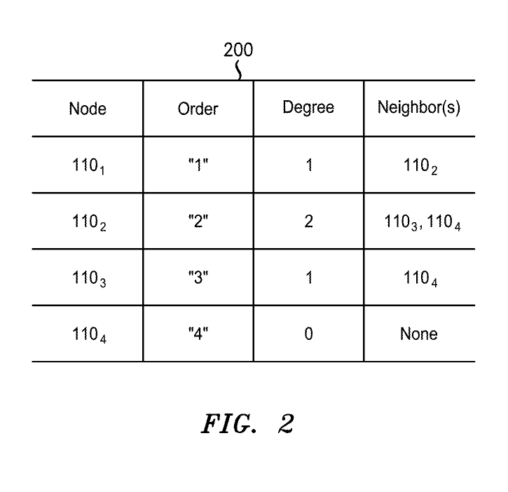

FIG. 2 illustrates a table 200 summarizing the neighboring nodes and the degree for each of the nodes 110 of graph 100 of FIG. 1. Although relatively easier to compute for the simplified example of FIG. 1, computing and determining, for example in response to dynamic queries, the neighboring nodes or the degrees in a graph that includes a large number of nodes (e.g., millions or billions) or an even larger number of interconnections (e.g., tens of millions or billions) is a non-trivial, computationally intensive task that requires a significant amount of time and resources (e.g., processor speed, memory, etc.). Even large or distributed modern computers face the challenge of efficiently organizing and processing desired information from graphs with over 1 billion nodes, 10 billion edges, and auxiliary information (such as edge weights) in memory.

There is an ongoing challenge and need to develop algorithms and data structures for systems and methods to effectively process information in ever larger graphs. The present disclosure describes systems and methods for organizing and processing information in graphs which may provide a number of advantages, such as reducing memory size requirements proportional to the number of edges in the graph, allowing efficient queries about nodes, neighbors and graph structure, and providing for efficient multiple iterations through the graph.

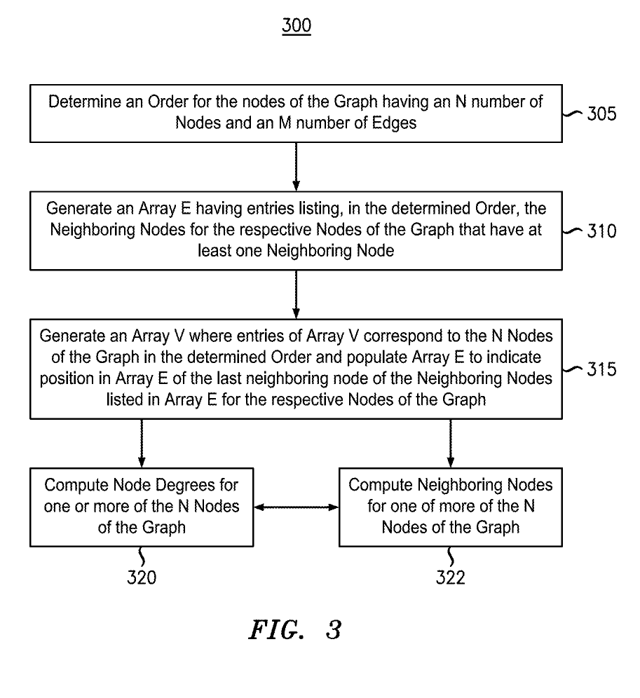

FIG. 3 shows an example process 300 for constructing a collection of datasets for organizing and processing information in a graph having an N number of nodes and M number of edges in accordance with aspects of the disclosure. A particular application of the process 300 is also described in conjunction with graph 100 of FIG. 1, which includes four nodes (N=4) and four edges (M=4).

In one aspect, the process 300 includes a step 305 for determining or assigning an order for the N number of nodes of an N-node graph. The order assigned to the nodes of the graph may be determined in a number of ways. In one embodiment, each of the N number of nodes of graph may be assigned with a unique order from one to N. This embodiment is illustrated for graph 100 (N=4) of FIG. 1, where node 110₁ is designated as the first node or node “1”, node 110₂ is designated as the second node or node “2”, node 110₃ is designated as the third node or node “3”, and node 110₄ is designated as last node or node “4”. The assigned order is also illustrated in the table 200 of FIG. 2.

In other embodiments the assigned order may be determined (or pre-determined) by other suitable means, such as by lexicographically ordering the N nodes based on one or more attribute values of the entities represented by the nodes. For example, assuming that nodes of a graph represent web-pages and the unidirectional edges represent links from one web-page to other web-pages, each node (or web-page) may be designated with an assigned order based on the unique uniform resource location (“URL”) of the respective web-pages, names (or titles) of the web-pages, or a value of any other type of attribute (or like attributes) of the respective web-pages.

While any suitable method may be employed for determining an order for the nodes, it may be preferable, for reasons that will be more apparent below, that the first node in the assigned order is one that has neighboring nodes (such as node 110₁ of graph 100) as opposed to a node that has no neighboring nodes (such as node 110₄ of graph 100). However, this is neither necessary nor a limitation for process 300, as described further below.

In step 310, the process includes generating an array E [1, 2, . . . , M] having entries that indicate, in the node order determined in step 305, the neighboring nodes for the nodes of the graph that have neighboring nodes. Since in accordance with this aspect array E only includes entries for nodes of the graph that have neighboring nodes, array E has an M number of entries corresponding to the M number of edges represented in the graph.

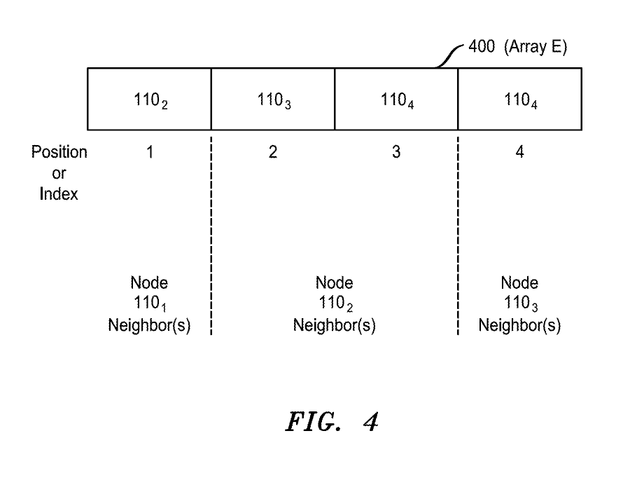

FIG. 4 illustrates an array 400 as an example of generating, in step 310, an array E for the graph 100 of FIG. 1. As seen in FIG. 4, array 400 includes four entries, corresponding to the number of edges of the graph 100 (M=4), namely, 115₁, 115₂, 115₃, and 115₄. The entries of the array 400 indicate, in the node order determined in step 305, the neighboring nodes for each of the nodes of the graph 100 that have at least one neighboring node, namely, nodes 110₁, 110₂, and 110₃. It is noted that for nodes that do not have neighboring nodes (e.g., node 110₄ of graph 100), there are no entries recorded in array 400.

The entries of array 400 are ordered based on the node order determined in step 305. Thus, in the first position of array 400, the neighboring nodes of the first node (node “1”) in the designated order, namely, node 110₁, are entered into array 400. Since node 110₁ has only one neighboring node, namely, node 110₂, a single entry indicating node 110₂ is placed in the first indexed entry (E[1]=“110₂”) of array 400.

Continuing, the neighboring nodes of the second node (node “2”) in the designated order, node 110₂, are entered into the array 400. Since node 110₂ has two neighboring nodes, node 110₃ and 110₄, two entries (E[2]=“110₃”, E[3]=“110₄”) indicating the two neighboring nodes of node 110₂ are placed into the second and third indexed positions of the array 400. It is noted here that the order in which these two neighboring nodes are indicated in the second and third position of the array 400 need not necessarily be in designated order as show in array 400, but may provide certain efficiencies when searching for neighboring nodes as described further below.

Next, the neighboring nodes of third node (node “3”) in the designated order, node 110₃, are entered starting with the next available position of the array 400. Since node 110₃ has a single neighboring node, namely, node 110₄, a single entry (E[4]=“110₄”) indicating the neighboring node is placed into the fourth position of the array 400.

As all entries of the array 400 have been populated in the designated node order of step 305, or, more notably, the last remaining node (node “4”) in the designated order, node 110₄, does not have any neighboring nodes, the generation of array 400 is completed.

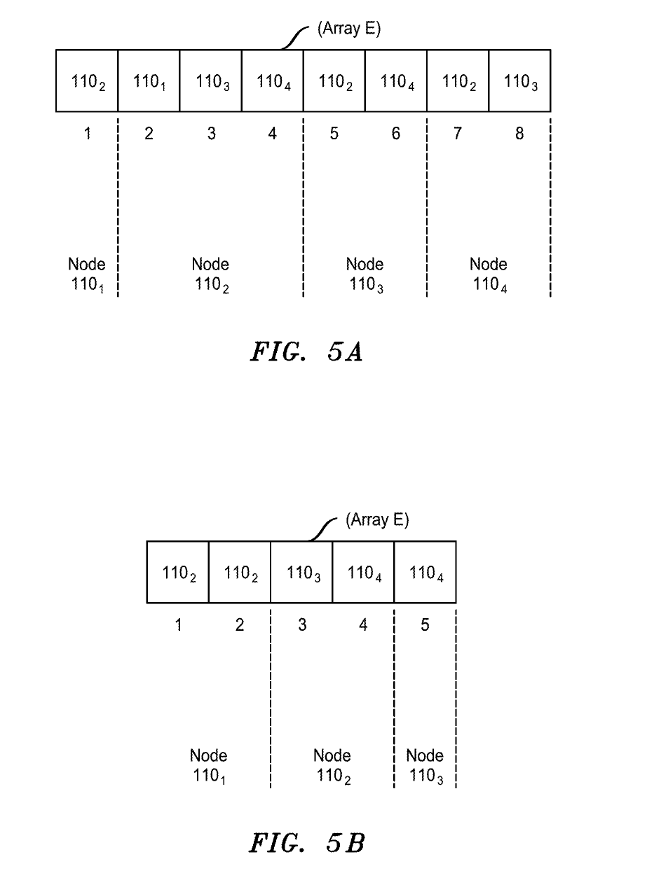

It is noted that the foregoing description does not vary in principle depending upon the number or type of interconnections in a graph although the neighboring nodes (and the number of entries) indicated by array E may vary. For example, FIG. 5a illustrates an alternate embodiment of an array E that may be generated in step 310 for the graph 100 of FIG. 1 assuming that each of the edges 115 of the graph 100 is a bi-directional edge (equivalent to two opposing unidirectional edges) instead of the unidirectional edges shown in FIG. 1. Similarly, FIG. 5b illustrates another embodiment of the array E that may be generated in step 310 assuming the presence of an additional parallel unidirectional edge in graph 100 from node 110₁ to node 110₂ in addition to the unidirectional edges already depicted in FIG. 1.

Returning to the process 300 of FIG. 3, step 315 includes generating an array V[1, 2, . . . , N] having an N number of entries where each of the respective N entries corresponds to respective ones of the N nodes of graph 100 in the designated order of step 305, and where the entries indicate the position of the last neighboring node of the neighboring nodes listed in array E for the respective nodes of the graph that have neighboring nodes. Respective entries for the nodes of the graph that do not have neighboring nodes (or do not have entries in the array E) are populated with the value of the immediately prior entry of array V or with a zero if there is no such prior entry.

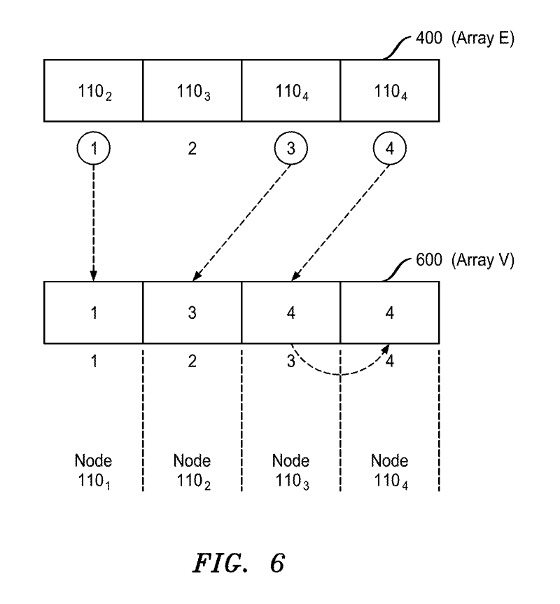

FIG. 6 illustrates an array 600 as an example of generating an array V for the graph 100 of FIG. 1 in step 315. To aid understanding, array 400 (array E) of FIG. 4, is also depicted again in FIG. 6. As seen in FIG. 6, array 600 includes four entries corresponding to the number of nodes (N=4) of the graph 100. Each of the four entries in array 600 corresponds with a respective node of graph 100 and is populated in the same node order designated in step 305, namely, node “1”, node “2”, node “3”, and node “4”.

Thus, the first entry (V[1]) of array 600 corresponds to node 110₁, since node 110₁ was designated as the first node or node “1” in the node order determined in step 305. As the ending position of last neighboring node of the neighbor node list for node 110₁ in array E is the first position (E[1]) in array 400, a “1” is recorded into the first entry (V[1]=“1”) of array 600 for node 110₁.

Next, the second entry (V[2]) of array 600 corresponds to node 110₂, since node 110₂ was designated as the second node or node “2” in the node order determined in step 305. As the ending position of the last neighboring node of the neighbor node list of node 110₂ in array E corresponds to the third position (E[3]) in array 400, a “3” is populated into the second entry (V[2]=“3”) for node 110₂ in array 600.

Next, the third entry (V[3]) of array 600 corresponds to node 110₃, since node 110₃ was designated as the third node or node “3” in the node order determined in step 305. As the neighbor node list of node 110₃ ends with the last neighboring node listed in the fourth position (E[4]) in array 600, a “4” is recorded into the third entry (V[3]=“4”) for node 110₃ in array 600.

Next, the last and fourth entry (V[4]) of array 600 corresponds to node 110₄, as node 110₄ was designated as the last node or node “4” in the node order determined in step 305. Since node 110₄ was determined as not having any neighboring nodes in step 310 and thus has no neighboring nodes listed in array 400, the value of the immediately prior entry in array 600 is used or repeated in the entry corresponding to node 110₄. Thus, since the prior entry V[3] has the value of “4”, a “4” is also recorded into the fourth entry (V[4]=“4”) for node 110₄ in array 600.

A special case may arise at the onset of step 315 if during the determination of the node order in step 305, a node with no neighboring nodes (e.g., node 110₄ of graph 100) is designated as being the first node in the node order. In this situation, since there would be no prior entries in array V in step 315 as yet, and since there would also be no neighboring nodes listed in array 400 in step 310, a zero may be populated in the first position (V[1]=“0”) of array 600 in step 315, and the process of populating the remaining entries of the array 600 may continue in step 315 as described above.

After all respective entries of the array V have been populated for respective nodes of the graph in step 315, array V is completed.

In step 320 and step 322, the array E and array V that are constructed for a graph in accordance with the process disclosed herein are used for determining information regarding the graph.

In one embodiment, the node degrees of various nodes in a graph are computed using array V in step 320. A node degree for a particular node i (iε1 . . . N) of a N-node graph in the designated order of step 305 may be determined from array V by computing V[i]−V[i−1] for i≧2, and V[i] for i=1.

Continuing the example of graph 100 of FIG. 1 in conjunction with array 600 (array V) of FIG. 6, in step 320 the node degree for node 110₁ (i=1) may be determined (e.g., in response to a query) from array 600 as 1 (one) since V[1]=“1”. The node degree for node 110₂ (i=2) may be determined in step 320 from array 600 as 2 (two) since V[2]−V[1]=3−1=“2”. The node degree for node 110₃ (i=3) may be determined in step 320 from array 600 as 1 (one) since V[3]−V[2]=4−3=“1”. Finally, the node degree for node 110₄ (i=4) may be determined in step 320 from array 600 of FIG. 6 as 0 (zero) since V[4]−V[3]=4−4=“0”. It can be seen that the node degrees calculated using array V accurately match the node degrees for each of the nodes of the graphs as illustrated in FIG. 2.

In another embodiment, the neighboring nodes of a given node may be determined (e.g., in response to a query) in step 322 using array V and/or array E. For example, a given node i (iε1 . . . N) of a N-node graph in the designated order of step 305 that is determined to have a degree of zero as described in step 320 can be efficiently identified as a node that has no neighboring nodes.

Alternatively, for a given node i (iε1 . . . N) of a N-node graph in the designated order of step 305 that is determined to have a degree greater than zero in step 320 (or is otherwise known to have a degree greater than zero), the neighboring nodes for such nodes may be determined from array E as the entries starting from E[V[i−1]+1] and up to and including E[V[i]] for i>=2, and as entries starting with E[1] (i.e., the first entry in array E) and up to and including entry E[V[i]] for i=1.

For example, assume a query is received for the neighboring nodes of node 110₁ of graph 100. Using array 400 (array E) and array 600 (array V) of FIG. 6, the neighboring nodes of node node 110₁ (node “1”) (i=1) may be determined in step 322 as all nodes listed in array E starting from E[1] up to and including E[V[1]]. From array V, it can be seen that V[1]=“1”. Thus, the neighboring nodes of node “1” are nodes listed from E[1] up to and including E[1], or simply E[1]=node “2” (node 110₂).

By way of a second example, assume a query is for the neighboring nodes of node node 110₂ (or node “2”) of graph 100. Again using array 400 (array E) and array 600 (array V) in FIG. 6, the neighboring nodes of node “2” (i=2) may be determined in step 322 as the nodes listed in array E starting from entry E[V[1]+1] and up to and including entry E[V[2]]. From array V it can be determined that V[1]=“1” and V[2]=“3”. From array E it can be seen that the consecutive neighboring nodes listed in array E starting from E[2] and up to and including E[3] are node “3” and node “4” (or nodes 110₃ and nodes 110₄). Thus, nodes “3” and “4” are determined as the neighboring nodes of node “2”.

This approach may also be used to determine whether a first node is a neighboring node of a second node (or equivalently whether there is a direct path or edge from the second node to the first node). Assume for example, that a query is received to determine whether node “1” is a neighboring node of node “2” (or whether there is a directed edge from node “2” to node “1”). Since node “1” is not listed in the entries starting from E[2] (node “3”) and up to and including E[3] (node “4”) as determined in step 322, it can be concluded that node “1” is not a neighboring node of node “2”.

The various aspects of the systems and methods disclosed herein may incur a number of advantages for processing graphs, particularly for processing large graphs including thousands or millions of nodes or edges. For example, degrees of various given nodes of a graph may be determined with a constant number of computations using array V. In other embodiments, other determinations, such as the maximum node degree of the nodes of the graph or distribution of the degrees of the nodes of the graph may also be determined efficiently from array V. Furthermore determining whether a given node of the graph is a neighboring node of another given node of the graph (a binary operation that may be accomplished in log₂ Δ amount of time, where Δ is the maximum node degree of the graph), or determining the neighboring nodes of given nodes of the graph, may be accomplished by examining only a focused and relevant subset of the entries of the array E (as opposed to a larger or all set of entries).

The various embodiments disclosed herein are applicable in a number of contexts. For example, it is often desirable to rank (or score) nodes of a graph to determine nodes that are relatively more significant than other nodes with respect to some criteria. Where the nodes of the graph represent webpages (or websites) and the edges interconnecting the nodes represent directed hyperlinks from one webpage to another webpage, the nodes of the graph may be ranked using a ranking algorithm to assess the relative popularity of the websites based on the number of directed edges to particular nodes of the graph from other nodes of the graph. A node that is directly or indirectly reachable from many other nodes of the graph may be deemed to be more popular than another node that is reachable by fewer (or possible none) of the other nodes of the graph.

Similar (or other) ranking considerations may apply to graphs representing other types of information, such as social network graphs in which the nodes may represent users (or other entity) of the social network and the edges may represent connections (or relationships) of a user (or entity) to other users (or entities) of the social network graph.

A ranking algorithm (such as the well known PageRank algorithm developed by Google Inc. to rank or score webpages (or websites)), typically ranks the nodes of a graph by starting with an initial rank (e.g., each node of the graph may be assumed to have an equal rank initially), and then iteratively adjusting the rank of the nodes of the graph until the adjusted ranks converge to a final adjusted ranking. An initial rank associated with each respective node of the graph is evenly distributed to each of the neighboring nodes of the respective nodes. This results in an adjusted rank for each respective node, which is then further adjusted by reiterating the distributing step to distribute the adjusted ranks of the respective nodes to the neighboring nodes. The ranking process may end with final rankings for the respective nodes when (typically after a number of iterations) the adjusted ranks that result for the respective nodes after the distribution to the neighboring nodes converge (e.g., the adjusted ranks of the nodes do not further change as a result of the iterations or change less than a pre-determined threshold after a number of the iterations).

Thus, in some embodiments the systems and methods disclosed herein may supplement, or be integrated into, systems and methods for ranking or scoring the nodes of a graph to, for example, determine neighboring nodes or node degrees associated with one or more nodes as part of the ranking process. The systems and methods disclosed herein may also be generally incorporated into, or supplement, any other system and method for processing graphs in a similar manner.

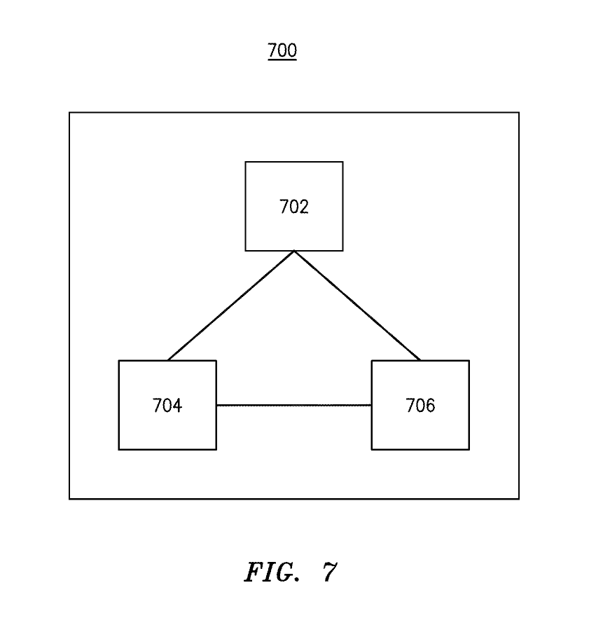

FIG. 7 depicts a high-level block diagram of a computing apparatus 700 suitable for implementing various aspects of the disclosure (e.g., one or more steps of process 300). Although illustrated in a single block, in other embodiments the apparatus 700 may also be implemented using parallel and distributed architectures. Thus, for example, various steps such as those illustrated in the example of process 300 may be executed using apparatus 700 sequentially, in parallel, or in a different order based on particular implementations. Apparatus 700 includes a processor 702 (e.g., a central processing unit (“CPU”)), that is communicatively interconnected with various input/output devices 704 and a memory 706.

The processor 702 may be any type of processor such as a general purpose central processing unit (“CPU”) or a dedicated microprocessor such as an embedded microcontroller or a digital signal processor (“DSP”). The input/output devices 704 may be any peripheral device operating under the control of the processor 702 and configured to input data into or output data from the apparatus 700, such as, for example, network adapters, data ports, and various user interface devices such as a keyboard, a keypad, a mouse, or a display.

Memory 706 may be any type of memory suitable for storing electronic information, such as, for example, transitory random access memory (RAM) or non-transitory memory such as read only memory (ROM), hard disk drive memory, compact disk drive memory, optical memory, etc. The memory 706 may include data (e.g., graph 100, array V, array E, or other data) and instructions which, upon execution by the processor 702, may configure or cause the apparatus 700 to perform or execute the functionality or aspects described hereinabove (e.g., one or more steps of process 300). In addition, apparatus 700 may also include other components typically found in computing systems, such as an operating system, queue managers, device drivers, or one or more network protocols that are stored in memory 706 and executed by the processor 702.

While a particular embodiment of apparatus 700 is illustrated in FIG. 7, various aspects of in accordance with the present disclosure may also be implemented using one or more application specific integrated circuits (ASICs), field programmable gate arrays (FPGAs), or any other combination of hardware or software. For example, the graph and the datasets disclosed herein (e.g., array V, E) may be stored in various types of data structures (e.g., linked list) which may be accessed and manipulated by a programmable processor (e.g., CPU or FPGA) that is implemented using software, hardware, or combination thereof.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. A computer-implemented method for processing a graph having an N number of nodes interconnected by an M number of edges, the method comprising:
generating, using a processor, an array E having an M number of entries for listing neighboring nodes for respective nodes of the N nodes of the graph that have at least one neighboring node, wherein the neighboring nodes are listed in array E for the respective nodes of the graph that have at least one neighboring node in a determined order assigned to the N number of nodes of the graph; and,
generating, using the processor, an array V having an N number of entries that correspond, in the determined order, to the N number of nodes of the graph, and, populating entries of array V that correspond to the nodes of the graph having at least one neighboring node listed in array E to respectively indicate a position in array E of a last neighboring node listed in array E for the corresponding node.

2. The method of claim 1, further comprising:
populating at least one of the entries of array V that corresponds to a node of the graph that does not have any neighboring nodes with a value of an immediately prior entry populated into array V.

3. The method of claim 1, further comprising:
populating at least one of the entries of array V that corresponds to a node of the graph that does not have any neighboring nodes with a value of zero.

4. The method of claim 1, further comprising:
determining a degree of a given node i of the N nodes of the graph from one or more populated entries of array V.

5. The method of claim 4, wherein determining the degree of the given node i from one or more populated entries of array V further comprises:
computing a value V[i]−V[i−1] from array V as the degree of the given node i.

6. The method of claim 5, further comprising:
determining that the given node i does not have any neighboring nodes from array V based on a determination that V[i]−V[i−1]=0.

7. The method of claim 5, further comprising:
determining that the given node i of the graph has at least one neighboring node from array V based on a determination that V[i]−V[i−1]>=1.

8. The method of claim 1, further comprising:
determining neighboring nodes of a given node i of the N nodes of the graph using array V and array E by computing entries in array E starting from E[V[i−1]+1] and up to and including E[V[i]].

9. The method of claim 1, further comprising:
determining whether a first given node of the N nodes of the graph is a neighboring node of a given node i of the N nodes of the graph by searching entries in array E from E[V[i−1]+1] and up to and including E[V[i]].

10. The method of claim 1, further comprising:
utilizing array E and array V to determine a relative rank for one or more nodes of the N nodes of the graph.

11. An apparatus for processing a graph having an N number of nodes interconnected by an M number of edges, the apparatus comprising:
a processor;
a memory communicatively connected to the processor, the memory configured to store the one or more data structures and one or more executable instructions, which, upon execution by the processor, configure the processor to:
generate, in the memory, an array E having an M number of entries for listing neighboring nodes for respective nodes of the N nodes of the graph that have at least one neighboring node, wherein the neighboring nodes are listed in array E for the respective nodes of the graph that have at least one neighboring node in a determined order assigned to the N number of nodes of the graph; and,
generate, in the memory, an array V having an N number of entries that correspond, in the determined order, to the N number of nodes of the graph, and, populate entries of array V that correspond to the nodes of the graph having at least one neighboring node listed in array E to respectively indicate a position in array E of a last neighboring node listed in array E for the corresponding node.

12. The apparatus of claim 11, wherein the one or more executable instructions further configure the processor to:
populate at least one of the entries of array V that corresponds to a node of the graph that does not have any neighboring nodes with a value of an immediately prior entry populated into array V.

13. The apparatus of claim 11, wherein the one or more executable instructions further configure the processor to:
populate at least one of the entries of array V that corresponds to a node of the graph that does not have any neighboring nodes with a value of zero.

14. The apparatus of claim 11, wherein the one or more executable instructions further configure the processor to:
determine a degree of a given node i of the N nodes of the graph from one or more populated entries of array V.

15. The apparatus of claim 14, wherein the one or more executable instructions further configure the processor to:
compute a value V[i]−V[i−1] from array V as the degree of the given node i.

16. The apparatus of claim 11, wherein the one or more executable instructions further configure the processor to:
determine that the given node i does not have any neighboring nodes from array V based on a determination that V[i]−V[i−1]=0.

17. The apparatus of claim 15, wherein the one or more executable instructions further configure the processor to:
determine that the given node i of the graph has at least one neighboring node from array V based on a determination that V[i]−V[i−1]>=1.

18. The apparatus of claim 11, wherein the one or more executable instructions further configure the processor to:
determine neighboring nodes of a given node i of the N nodes of the graph using array V and array E by computing entries in array E starting from E[V[i−1]+1] and up to and including E[V[i]].

19. The apparatus of claim 11, wherein the one or more executable instructions further configure the processor to:
determine whether a first given node of the N nodes of the graph is a neighboring node of a given node i of the N nodes of the graph by searching entries in array E from E[V[i−1]+1] and up to and including E[V[i]].

20. The apparatus of claim 11, wherein the one or more executable instructions further configure the processor to:
utilize array E and array V to determine a relative rank for one or more nodes of the N nodes of the graph.
